(19) United States
(12) Patent Application Publication
(10) Pub. No.: US 2023/0021154 A1
(43) Pub. Date: Jan. 19, 2023

(54) SYSTEM TO USE CURVE DRAWING TO ENHANCE RESULT OF FINANCIAL SECURITY SCREENING AND SEARCHING

(71) Applicant: Adwin JAHN, Fremont, CA (US)

(72) Inventor: Adwin JAHN, Fremont, CA (US)

(21) Appl. No.: 17/860,613

(22) Filed: Jul. 8, 2022

Related U.S. Application Data
(60) Provisional application No. 63/223,204, filed on Jul. 19, 2021.

(51) Int. Cl. G06Q 40/04

(52) U.S. Cl. CPC G06Q 40/04

(57) ABSTRACT

The present disclosure provides a method of enriching financial screening results by allowing users to depict a desired curve shape. In an embodiment, a panel or window in a graphical user interface is provided to enable a user to compose a curve with a desired shape. The present disclosure will use the characteristics of the drawn curve to search a database for one or more symbols with similar chart patterns. Search results will present a number of most similar stock candidates in the graphic user interface and their information such as name, symbol, stock time series history, latest price and similarity score.

### CROSS-REFERENCE TO RELATED APPLICATION

This application claims the benefit of priority from U.S. Provisional Application No. 63/223,204 entitled “SYSTEM TO USE CURVE DRAWING TO ENHANCE RESULT OF FINANCIAL SECURITY SCREENING AND SEARCHING” filed Jul. 19, 2021, the entire contents of which are incorporated herein by reference.

### TECHNICAL FIELD

The present disclosure relates generally to screening financial security, searching financial security, sketch-based search, time series search, trend matching for financial security and/or characteristics matching.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In an on-line financial screening service, a database of financial information is searched to find financial security matching user defined financial search criteria, such as Stock Price, Price/Earnings Ratio, Current Ratio, Debt/Equity Ratio, Cash/Price ratio, Earnings per Share Growth-1 Yr, Earnings per Share Growth-5 Yr, Institutional Holdings %, Price/Book Ratio, and Price/Cash Flow Ratio.

### SUMMARY

Aspects of the present disclosure provide a system for searching for stock symbols with similar curve or pattern based on an input curve or pattern. For example, the system can include an interface and a search engine coupled to the interface. The interface can be configured to receive an input curve or a first symbol and one or more parameters. The search engine can be configured to search a database for one or more second symbols based on the input curve and the parameters or based on a first curve of the first symbol corresponding to the parameters, and display the second symbols on the interface. In an embodiment, a second curve of each of the second symbols has a similarity score over a threshold. In another embodiment, the parameters can include a time range and a time interval.

In an embodiment, the interface can be further configured to display a plurality of default curves, and the input curve is one of the default curves. In another embodiment, the interface can include a graphic user interface (GUI) with touch screen capability, and the input curve is drawn on the GUI.

In an embodiment, the interface can be further configured to receive one or more indicators, and the second symbols can be searched based on the indicators, the input curve and the parameters or based on the indicators and the first curve of the first symbol corresponding to the parameters. In another embodiment, the interface can be further configured to receive one or more candlestick patterns, and the second symbols can be searched based on the candlestick patterns, the input curve and the parameters or based on the candlestick patterns and the first curve of the first symbol corresponding to the parameters.

In an embodiment, the search engine can be further configured to save the input curve in the database. In another embodiment, the system can further include a memory that is coupled to the search engine, and the search engine can be further configured to save the input curve in the memory.

In an embodiment, the first symbol and the second symbols belong to at least two financial markets.

Aspects of the present disclosure also provide a method for searching for stock symbols with similar curve or pattern based on an input curve or pattern. For example, the method can include receiving an input curve or a first symbol and one or more parameters. The method can further include searching a database for one or more second symbols based on the input curve and the parameters or based on a first curve of the first symbol corresponding to the parameters. The method can further include displaying the second symbols. In an embodiment, the method can further include displaying a plurality of default curves, wherein the input curve is one of the default curves.

In an embodiment, the method can further include receiving one or more indicators, wherein the second symbols are searched based on the indicators, the input curve and the parameters or based on the indicators and the first curve of the first symbol corresponding to the parameters. In another embodiment, the method can further include receiving one or more candlestick patterns, wherein the second symbols are searched based on the candlestick patterns, the input curve and the parameters or based on the candlestick patterns and the first curve of the first symbol corresponding to the parameters.

In an embodiment, a second curve of each of the second symbols can have a similarity score over a threshold.

In an embodiment, the method can further include saving the input curve. In another embodiment, the first symbol and the second symbols belong to at least two financial markets.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a graph illustrating a relation between stock prices and economic cycle;

FIGS. 2A to 2C show three stock charts;

FIG. 3 is a functional block diagram of an exemplary system in accordance with some embodiments of the present disclosure;

FIGS. 4A to 4F are various graphs of exemplary user interfaces in accordance with some embodiments of the present disclosure;

FIG. 5 shows an exemplary system usage flow for draw and search in accordance with a first embodiment of the present disclosure;

FIG. 6 shows an exemplary system usage flow for match by symbol in accordance with a second embodiment of the present disclosure;

FIG. 7 shows an exemplary system usage flow for saving drawings in accordance with a third embodiment of the present disclosure;

FIG. 8 shows an exemplary system usage flow for view saved in accordance with a fourth embodiment of the present disclosure; and

FIG. 9 shows an exemplary system usage flow for view sharing in accordance with a fifth embodiment of the present disclosure;

### DETAILED DESCRIPTION OF EMBODIMENTS

The word “exemplary” is used herein to mean, “serving as an example, instance or illustration.” Any embodiment of construction, process, design, technique, etc., designated herein as exemplary is not necessarily to be construed as preferred or advantageous over other such embodiments. Particular quality or fitness of the examples indicated herein as exemplary is neither intended nor should be inferred.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the apparatus (or device) in use or operation in addition to the orientation depicted in the figures. The apparatus (or device) may be otherwise oriented (rotated 90 degrees or at other orientations) and the spatially relative descriptors used herein may likewise be interpreted accordingly.

The present disclosure is directed to a system to use curve drawing to enhance result of financial security screening and searching, an enrich financial security search result by using free hand curve drawing as an input source, and a sketch based financial securities search and screener. The present disclosure also provides a method of consuming free hand curve drawing in graphical user interface as one of the search inputs. The present disclosure provides users with a greater degree of flexibility to depict the desired curve shape of financial security. The present disclosure uses the characteristics of the drawn curve to search a database for one or more symbols with similar chart patterns. For example, a user may draw a letter W shape curve to depict the desire to search the database for stock candidates with double-bottom patterns, which typically signals the reversal and the beginning of a potential uptrend.

In general, financial market analysis (including stocks, commodity futures, bonds, forex, equity, exchange traded fund (ETF), crypto currency, foreign exchange market etc.) can be categorized into two main methods, i.e., fundamental analysis and technical analysis.

Fundamental analysis is a method of measuring a security's intrinsic value by examining related economic and financial factors. Fundamental analysts study anything that can affect the security's value. For example, in fundamental analysis an analyst needs to look at the financial statements of a company, its business model, overall macroeconomic scenarios, management capabilities and many more thins for coming to a specific fair value of a company. For stocks, fundamental analysis uses revenues, earnings, future growth, return on equity, profit margins, and other data to determine a company's underlying value and potential for future growth. If an analyst calculates that the stock's value should be higher than the stock's current market price, he may publish a buy or overweight rating for the stock, which acts as a recommendation to investors who follow the analyst. On the contrary, the analyst can issue a sell or underweight recommendation if he calculates a lower intrinsic value than the current stock price and considers the stock overvalued.

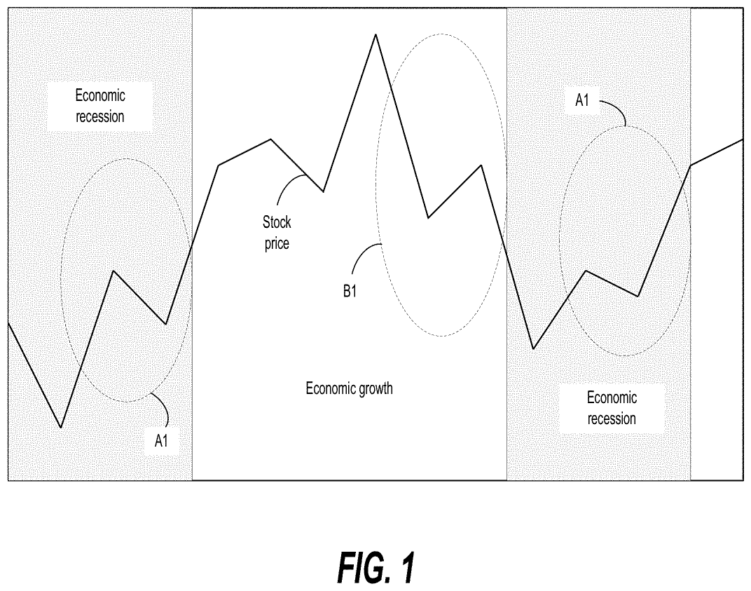

Fundamental analysts believe that there is a cause and effect between fundamental factors and price changes, which means that if the fundamental information is positive the price should go up, or the price should go down. However, such a correlation between fundamental factors and price changes is present only in the short-term horizon and only to a limited extent. The stock market itself is usually the best predictor of the future fundamental trend. On a medium- and long-term basis, prices start rising in a new bull trend while the economy is still in recession, as indicated by “A1” in FIG. 1, even when there is no cause for such a bull trend; and prices have fallen for a period of time since a new bear trend begins while the economy is still growing, as indicated by “B1” in FIG. 1. There may be a time-lag of several months by which the fundamental trend follow the stock market trend.

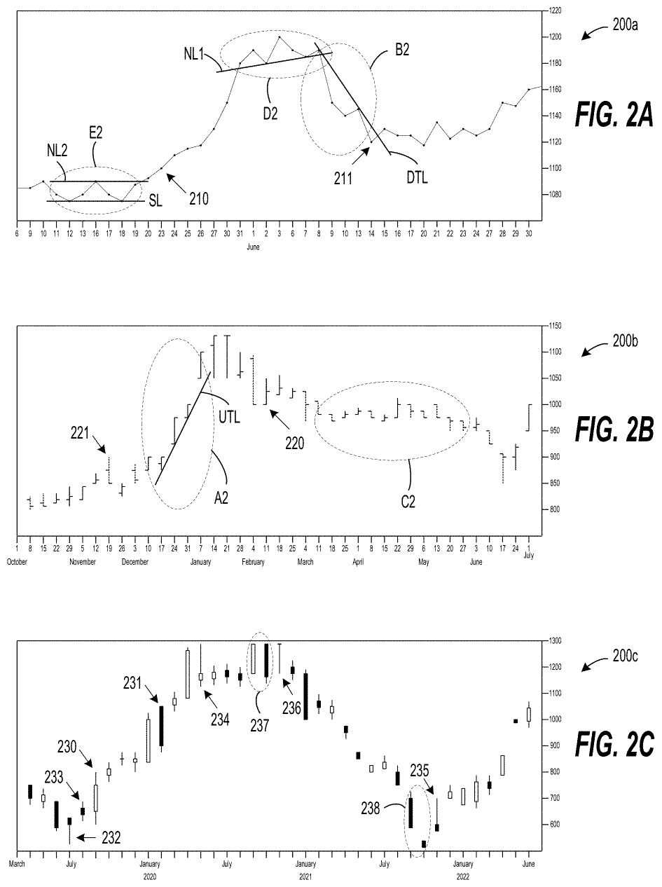

Technical analysis can identify trend changes that precede the fundamental trend and help investors identify turning points which they cannot see because the fundamental factors have not changed yet. Technical analysis is conducted based on price over time and volume. All patterns and indicators are derived from these two basic data points. Price over time can be represented by three most popular and widely used charts, i.e., line charts, bar charts and candlestick charts. FIGS. 2A to 2C show a line chart 200a, a bar chart 200b and a candlestick chart 200c, respectively. The X axis, i.e., the time axis, can have units in months (see FIG. 2C), weeks (see FIG. 2B), days (see FIG. 2A), hours, few mins or even few seconds. The shorter the units, more detailed the chart becomes. The Y axis, i.e., the price axis, can be a linear (or called arithmetic) scale or a logarithmic (or called log) scale. Log price scales may be better than linear price scales at showing less server price fluctuations.

In the line chart 200a, each price point is represented as a dot, which represents the closing price of a stock at the end of a unit of time. For example, a dot 210 represents the closing price of 1110 of the stock at May 23, and a dot 211 represents the closing price of 1120 of the stock at June 14. These dots can be joined together to form a line.

The bar chart 200b includes a series of bars, each of which has four price points, i.e., open, close, high and low. Specifically, a vertical bar is used to connect the high and the low, and two horizontal lines are used to indicate the opening price (left) and the closing price, respectively. For example, a bar 220 indicates that the price of a stock at February 11 has open, close, high and low of 1000, 1025, 1050 and 1000, respectively. In FIG. 2B, the bars are represented by a sloid line when the closing price is higher than or equal to the opening price or a dashed line when closing price is lower than the opening price. For example, a bar 221 indicates that the stock at November 19 has an opening price of 875 and a closing price of 850, which is lower than the opening price.

Candlestick charts are derived from Japan, and are thus often referred to as Japanese candlestick charts. In candlestick charts, price behavior during each unit of time is represented in the form of a candle. Each candle has a body and two wicks. The body represents the distance between the opening price and the closing price of a stock, and the upper and lower wicks represent the high and low of a candle, respectively. If the closing price of a stock is higher than the opening price during a particular unit of time, the candle is green or hollow. For example, a candle 230 is hollow, the body of which represents the opening price of 650 and closing price of 750 and the lower and upper wicks of which represent the high and low of the candle 230, which are 800 and 600, respectively. If the closing price of a stock is lower than the opening price during a particular unit of time, the candle is red or solid. For example, a candle 231 is solid, the body of which represent the opening price of 1050 and the closing price of 900, which is lower than the opening price.

Stock market can be in an up-trending phase, as indicated by “A2” in FIG. 2B, a down-trending phase, as indicated by “B2” in FIG. 2A,) or a range-bound (or called consolidation) phase, as indicated by “C2” in FIG. 2B. During the up-trending phase A2, an uptrend line UTL can be formed by joining pivot points, e.g., the troughs, i.e., the lowest points of periodic pull-backs. The uptrend line UTL may be confirmed and be said to be the area of support if it is not broken in the pull back. On the contrary, during the down-trending phase B2, a downtrend line DTL can be formed by joining the peaks, i.e., the highest points of periodic pull-backs. The downtrend line DTL may be confirmed and be said to be the area of resistance if it is not broken in the pull back.

Generally, no trend will last forever. The market often reverses, and a move starts in the opposite direction of the prior move. Some well-defined patterns are found to be formed in a chart and indicate price reversals. For example, a head-and-shoulders pattern D2, if appearing after a sustained uptrend, is a bearish reversal pattern. The head-and-shoulders pattern D2 includes three consecutive peaks, with middle one (called head) higher than the other two (called left shoulder and right shoulder). A neck line NL1 can be formed by joining intermediate troughs of the head-and-shoulders pattern D2. Once the stock price falls and breaks below the neck line NL1, the target of the stock price may be considered as the distance between the neck line and the head, projecting from the breaking point. An inverse head-and-shoulders pattern is just the opposite of the head-and-shoulders pattern D2. The inverse head-and-should pattern appears after a sustained downtrend, and acts as a bullish reversal pattern.

As another example, a double-bottom pattern E2 (or triple-bottom pattern), which appears after a sustained downtrend, signals to investors that the stock price is about to stop falling and reverse uptrend. The double-bottom pattern E2 can be formed when the stock price tests a support line SL twice and is unable to break through. A trade entry can be initiated at the bread of a neck line NL2, and the target is measured as the distance between the troughs and the neck line NL2. On the contrary, a double-top pattern (or triple-top pattern) appears after a sustained uptrend and signals to investors that the stock price is about to stop rising and reverse downtrend. The double-top pattern can be formed when the stock price tests a resistance line twice and is unable to break through. Triangles, including symmetrical triangle, ascending triangle and descending triangle, flag, pennants, wedges are also common and very useful price reversal indications.

Historical price data in a stock chart can be used to derive technical indicators. For example, an N-day simple moving average (SMA) includes last N days of price data divided by N. Technical indicators can aid decision making in the stock market. For example, a stock price in an up-trending phase crossing a 5-day SMA, which includes the last 5 days of price data divided by 5, signals to investors that the stock price will rise in a short-term. On the contrary, a medium-term sell signal is given when the stock price breaks below a 21- or 55-day SMA. As another example, relative strength index (RSI), which measures the changes in price momentum over a specified period of time (6 days or 12 days), can signal to investors that the stock is overbought if it is over 70 or the stock is oversold if it goes below 30. Sometimes the indicator, e.g., RSI, does not always cross the zero line, e.g., 50, before giving a new buying or selling signal. These signals are called redistribution or re-accumulation. Exponential moving average (EMA), weighted moving average (WMA), stochastic oscillator (KD), moving average convergence/divergence (MACD), bias and average directional index (ADX) are also common and very useful technical indicators.

Candlestick charts have an edge over line charts and bar charts due to recognizable chart patterns, which can be formed by one, two or three consecutive candlesticks and indicate reversal of a prior move. For example, a hammer 232 is a single candle bullish reversal pattern, if appearing after a prolonged downtrend. The hammer 232 should have a small or no body, regardless of solid or hollow, a short or no upper wick, and a very long lower wick, as compared with the body and the upper wick, e.g., at least twice the length of the body. If there is a gap up opening or the price moves above the high of the hammer 232 the next day or in next two or three days, as indicated by a candle 233, the bullish reversal pattern can be confirmed or validated. On the contrary, a shooting start (a mirror image of a hammer) 234 appearing in a prolonged uptrend may represent a bearish reversal pattern.

As another example, an inverted hammer 235, if appearing after a prolonged downtrend, is also single candle bullish reversal pattern. The philosophy is that bears were not able to push the price below the opening price during the trading term. A later stock price above the high of the inverted hammer 235 can confirm the bullish reversal pattern. A hanging man 236 is the mirror image of the inverted hammer 235, and, if appearing after a prolonged uptrend, can indicate a bearish reversal pattern.

A bearish engulfing pattern 237 is a two-candlestick bearish reversal pattern if appearing after a sustained uptrend. The bearish engulfing pattern 237 includes a surging hollow candle followed by a plunging solid candle, the body of which completely engulfs the body of the previous hollow candle, which indicates that the closing price of the stock today is lower than the opening price yesterday, even though the stock price. On the contrary, a bullish engulfing pattern is a two-candlestick bullish reversal pattern if appearing after a sustained downtrend. The bullish engulfing pattern includes a plunging solid candle followed by a surging hollow candle, the body of which completely engulfs the body of the previous solid candle.

A bullish exhaustion gap pattern 238 is another two-candlestick bullish reversal pattern if appearing after a sustained downtrend. The bullish exhaustion gap pattern 238 includes a solid candle followed by a solid or hollow candle, with a gap between these two candles. On the contrary, a bearish exhaustion gap pattern includes a hollow candle followed by a solid or hollow candle, with a gap between these two candles.

In addition to price over time, technical analysis can be further conducted based on volume. Volume is counted as the number of shares that are traded in a specific time of period. Higher the volume in any particular move, the greater is the conviction in that move to continue greater distance in the direction. For example, a traded volume of a stock being higher than an average volume over a certain period of time in an up-trending phase may indicate that the stock price will keep on rising. Delivery % is a concept regarding volume. Generally, if the price of a stock rises with high delivery %, this signals to investors a positive conviction in the stock.

As described previously, if there is a gap up opening or the price moves above the high of the hammer 232 the next day or in next two or three days, the bullish reversal pattern can be confirmed or validated. Similarly, patterns, including bearish reversal patterns, e.g., the head-and-shoulders pattern D2, and bullish reversal patterns, e.g., the double-bottom pattern E2, can also be confirmed or validated by using technical indicators, candlestick chart, volume and/or other data. For example, the head-and-shoulders pattern D2 can be confirmed if the volumes at the right shoulder, the head and the left shoulder decrease gradually, if candles in a candlestick chart corresponding to the head-and-shoulders pattern D2 include the hanging man 236 or the bearish engulfing pattern 237, if the head-and-shoulders pattern D2 corresponds to a redistribution signal, and/or if the neck line NL1 is broken.

When a user desires to locate in an on-line financial screening service a stock with a particular curve shape over the time series presentation, e.g., the head-and-shoulders pattern D2 and the double-bottom pattern E2, he can define the curve shape through scripts and formula (see https://tickertape.tdameritrade.com/trading/easy-coding-traders-build-your-own-indicator-16689). For example, the writing script can be thinkScript, which is within product ThinkOrSwim (see: https://tlc.thinkorswim.com/center/reference/thinkScript/tutorials/Basic/Chapter-3---Defining-Inputs). However, these scripts and formula are not intuitive, and a user needs to spend time and have some talents in order to learn and master them. Other types of services allowing pattern matching are only providing predefined and fixed options (for example, finviz: finviz.com). The present disclosure provides a system that uses curve drawing to search a database for stock candidates. The curve drawing can be made or selected manually on an interface.

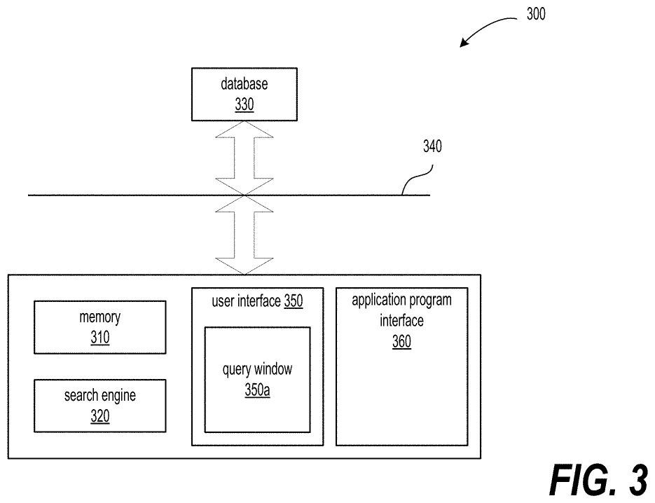

FIG. 3 is a block diagram of an exemplary system 300 in accordance with some embodiments of the present disclosure. The system 300 can be included in an electronic device, such as a computer, a mobile phone etc. For example, the system 300 can include a user interface 350, a memory 310, and a search engine 320. A database 330 communicates with the memory 310 and the search engine 320 via a network 340. The database 330 can be configured to store historic data and information of a variety of financial markets, such as stocks, commodity futures, bonds, forex, equity, exchange traded fund (ETF), crypto currency, foreign exchange market etc. For example, the database 330 can store historic price data of stocks in the market, such as daily prices, including open, close, high and low, stock charts of these stocks, such as line charts, bar charts and candlestick charts, technical indicators derived from the historic price data, such as SMA, RSI, KD and MACD, and volumes of these stocked that are traded every day. The system 300 with the database 330 storing stock candidate history will periodically retrieve up to date data from various electronic exchange trading platforms and update the record into the database 330.

The user interface 350 may be a graphic user interface (GUI) with touch screen capability, and include a query panel or window 350a, which enables users to compose a curve with desired shapes. For example, the query window 350a may display a plurality of patterns, a set of selectable parameters for users to customize the scope of search, e.g., time ranges, time intervals etc., technical indicators and candlestick chart patterns, which may be stored in the memory 310, and a user is allowed to select one of the patterns, one of the time ranges, one of the time intervals, and at least one of the technical indicators and the candlestick chart patterns. As another example, a user can draw a curve by hands on the query window 350a. The prevalence of devices with touch screen capability has made human-computer interaction, and sketching in particular, much easier than before. Time interval is always no greater than the time range. For example, matched with a 3 month daily chart means the time interval is 1 day and the time range is 3 months. In some embodiments, the user can also draw two or more curves, including a curve joining multiple closing prices, a moving average line, an uptrend (or downtrend) line connecting multiple pivot points, e.g., the uptrend line shown in FIG. 2B, etc., and select a ticker with start and end time to extract. In an embodiment, the user can click a position in canvas for the location of each pivot point to form an uptrend (or downtrend) line, instead of drawing the full trajectory.

The search engine 320, e.g., a processor and/or algorithm, can receive selection signal of search parameters, e.g., period of time, selection signal of indicators, e.g., RSI, SMA, KD etc., and a user input, e.g., a drawn curve, search the database 330 for similar stock symbols with similar chart patterns corresponding to the period of time, the indicators and the drawn curve, and display found similar stock symbols and their associated information on the user interface 350. For example, the search engine 320 will match and calculate similarity scores based on the input drawn curve, the indicator, the candlestick chart pattern and the parameters with the whole or a set of stock history charts stored in the database 330. The similarity score could be calculated by the similarity analysis between the sequence of the user's curve drawing shape and the stock candidate's time series sequence. However, it should be understood that different statistical analysis could also be used for detecting similar chart patterns. The search engine 320 then presents in the user interface 350 the similar stock candidates that have similarity scores over a threshold and their associated information such as stock symbol, time series history, latest price, similarity score etc. For example, the associated information can include the name, symbol, stock time series history, latest price, similarity score etc. In some embodiments, the search engine 320 may ranks a portion or all of the stock candidates that have similarity scores over the threshold. In some embodiment, the search engine 320, e.g., an algorithm, will give a higher similarity score to a candidate stock when its stock price changes direction when touching each pivot point.

In an embodiment, the drawn curve and associated information, e.g., time range and indicators, can be saved in the memory 310. In another embodiment, the drawn curve and the associated information and/or the user's information can be transmitted to and stored in the database 330, which can thus be shared with other users. The stored curves can be used to execute a search. For example, a user can load a curve stored in the memory 310 that was saved previously by himself or stored in the database 330 that was saved by himself or other users, and the search engine 320 can execute a search to find similar symbols with similar chart patterns to the curve. As another example, a user can input his information in the user interface 350 to enable the user interface 350 to display curves that are saved in the databased 330 by himself, and the search engine 320 can execute a search to find similar symbols with similar chart patterns to one of the curves that the user selects.

Draw and search covers multiple use cases. In an embodiment, a user can select a given indicator and draw a single line to match. In another embodiment, a user can use similar logic of single line drawing but draw more than one line before executing a match. The multiple lines search request will indicate the intention to receive a matched result of the intersection of these lines. For example, if a user draws an uptrend line joining multiple closing prices and a downtrend 200-day simple moving average line, it indicates that the matched result is obtained when the intersection of both criteria is satisfied.

Drawing on the user interface 350 is not limited to free hand drawing. For example, a straight line could be finished by two clicks, the first click being the start of the line and the second click indicating the end of line. A curve might be formed from three click signals from a user.

In some embodiments, the system 300 can further include an application program interface (API) 360, which can be installed in a mobile phone and specify time series data and parameters. A user can input a drawn curve and parameters with the API 360.

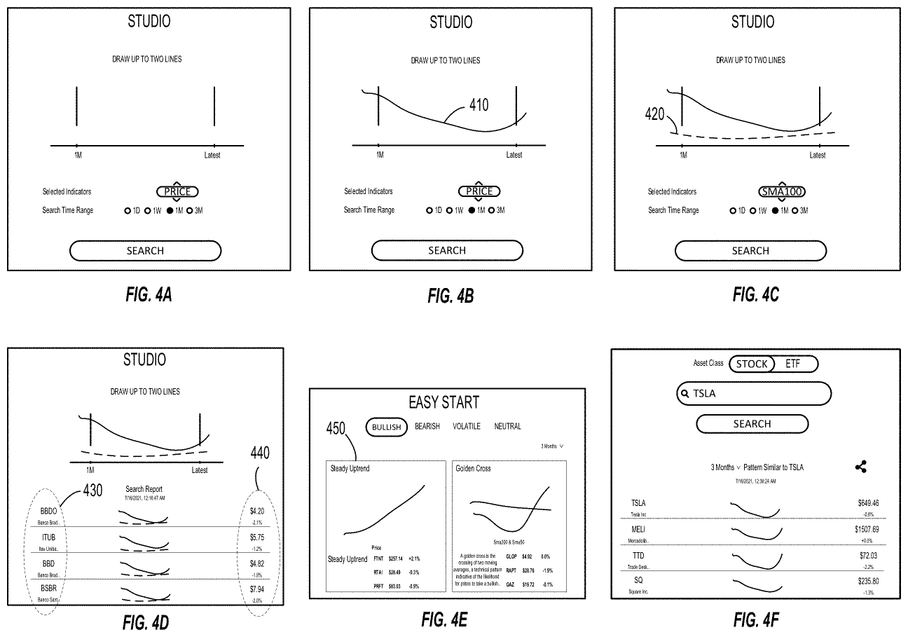

FIGS. 4A to 4D are various graphs of exemplary user interfaces, e.g., the user interface 350, for illustrating how the system 300 finds stock candidates based on drawn curves, parameters and indicators input by a user according to some embodiments of the present disclosure. As shown in FIG. 4A, the user selects the period of time of one month by clicking a button “1M” in “Search Time Range,” and scrolls the “Selected Indicators” to select “PRICE” as the indicator. As shown in FIG. 4B, the user draws a “PRICE” curve or pattern 410 within two time bars “1M” and “Latest.” In an embodiment, the user can draw the “PRICE” curve 410 by hands on the user interface 350. In another embodiment, the user can select the “PRICE” curve 410 from a plurality of default curves (or patterns) displayed on the query window 350a and stored in the memory 310. As shown in FIG. 4C, the user can further scroll the “Selected Indicators” to select “SMA100” (100-day simple moving average) as an additional technical indicator, and draw a “SMA100” curve 420. As shown in FIG. 4D, after the search engine 320 searches the database 330 for similar stock symbols with similar curves (or patterns), i.e., the “PRICE” curve 410 and the “SMA100” curve 420, that correspond to the period of time “1M,” the user interface 350 displays all the search results, including found similar stock symbols 430 and their associated information 440 such as closing prices.

In some embodiments, a user can also type a desired stock symbol and input a desired time range in the user interface 350, and the search engine 320 can search the database 330 for similar stock symbols with similar chart patterns to the desired stock symbol. As shown in FIG. 4F, the user types a desired stock symbol “TSLA” and input a time range of “3 Months” in the user interface 350, and the search engine 320 searches the databased 330 to find the stock candidates “MELI,” “TTD” and “SQ,” which have similar chart patterns to the desired stock symbol TSLA,” and display the search result, including the stock symbols “MELI,” “TTD” and “SQ” and their associated information, e.g., the closing prices, in the user interface 350.

In some embodiments, a combination of a drawn pattern and search parameters can be converted to a memorized item and visualized as a card, e.g., a card 450 shown in FIG. 4E, that users can just click and executes the search without drawing again. The user can also save his drawn curves and search parameters into a memorized card for future reuse.

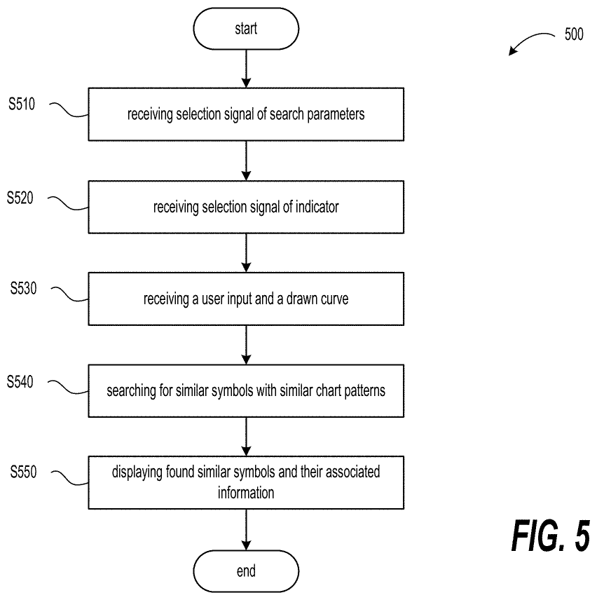

FIG. 5 is a flow chart illustrating an exemplary method or system usage flow 500 for drawing a curve or pattern and searching for stock symbols with similar curve or pattern accordance to some embodiments of the present disclosure. At step S510, a selection signal of search parameters is received. For example, the search parameters can be desired time range, which are input by a user in the user interface 350. At step S520, a selection signal of indicators can be received. For example, the indicators can be SMA, RSI, KD, MACD etc. and input by the user in the user interface 350. At step S530, a user input, e.g., a drawn curve, can be received. For example, the drawn curve can be selected from the default curves (or patterns) displayed on the query window 350a and stored in the memory 310, or drawn by the user himself. At step S540, similar symbols with similar chart patterns are searched based on the input drawn curve and the indicators. For example, the search engine 320 can match and calculate similarity scores based on the input drawn curve, the indicators and other parameters with the whole or a set of stock history charts stored in the database 330 to find similar stock symbols with similar curve and indicators. At step S550, the found similar stock symbols can be displayed. For example, the search engine 320 can display the found similar stock symbols and their associated information, e.g., closing prices, on the user interface 350. In an embodiment, steps S520 and S530 can be performed multiple times before step S540 is performed.

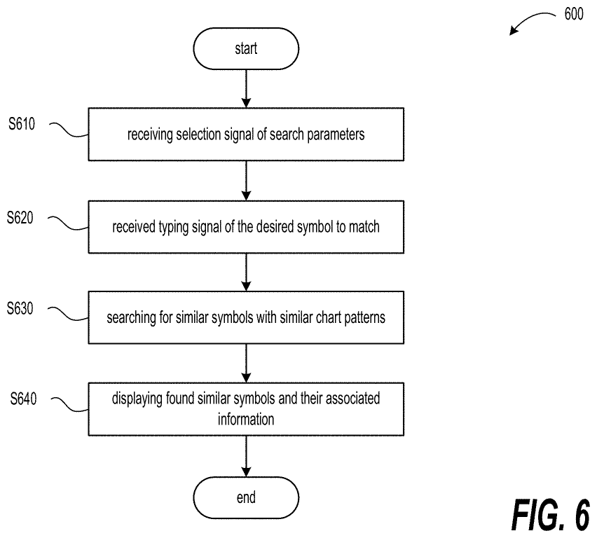

FIG. 6 is a flow chart illustrating an exemplary method or system usage flow 600 for typing a desired stock symbol and searching for stock symbols with similar curve or pattern accordance to some embodiments of the present disclosure. At step S610, a selection signal of search parameters, such as a desired time range, can be received in the user interface 350, for example. At step S620, a typing signal of the desired symbol to match is received. For example, the user can type the desired symbol in the user interface 350. At step S630, similar symbols with similar chart patterns to the desired symbol are searched based on the typed desired symbol and the input time range. For example, the search engine 320 can search, based on the desired symbol and the time range, the database 330 for the similar symbols, which have similar chart patterns to the desired symbol. At step S640, the found similar symbols and their associated information can be displayed in the user interface 350.

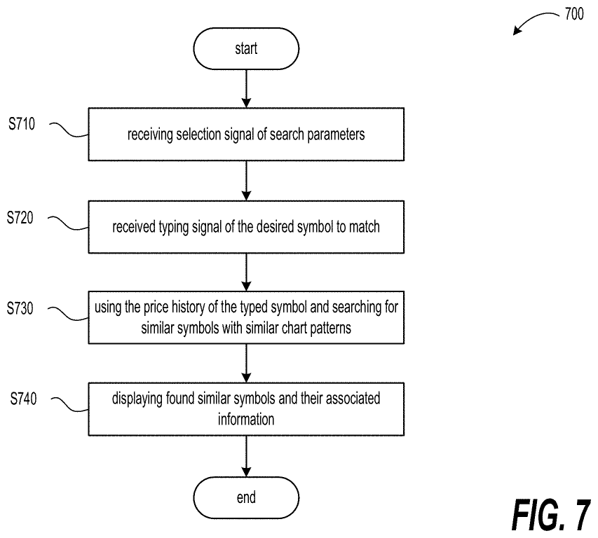

FIG. 7 is a flow chart illustrating an exemplary method or system usage flow 700 for typing a desired stock symbol and searching for stock symbols with similar chart patterns according to some embodiments of the present disclosure. At step S710, a selection signal of search parameters, such as a desired time range is received in the user interface 350, for example. At step S720, a typing signal of a desired symbol to match is received. At step S730, based on the typed symbol and the time range, symbols with similar chart patterns to the typed symbol are searched by using the price history of the typed symbol. At step S740, the found similar symbols and their associated information are displayed in the user interface 350.

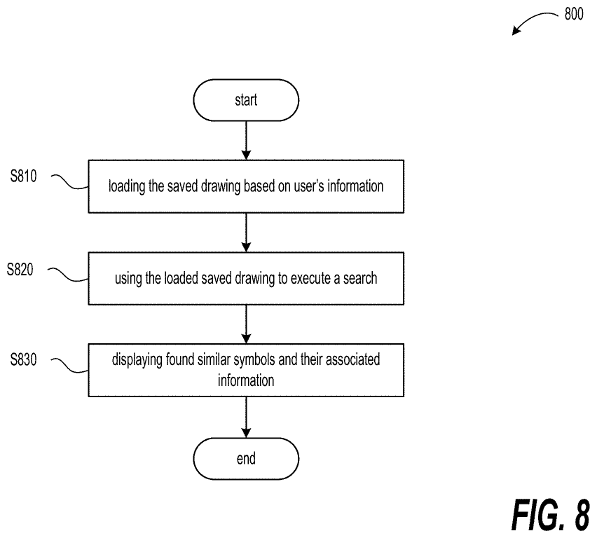

FIG. 8 is a flow chart illustrating an exemplary method or system usage flow 800 for using a saved curve to execute a search according to some embodiments of the present disclosure. At step S810, a curve previously saved by the user can be loaded based on a user's information. For example, a user can input his information in the user interface 350 to enable the user interface 350 to display the curves that the user has saved in the memory 310 or database 330, and the user can select and load one of the saved curves. At step S820, the loaded saved curve can be used to execute a search. For example, the search engine 320 can search the database 330 for similar symbols with similar chart patterns to the loaded saved curve. At step S830, found symbols and their associated information can be displayed in the user interface 350.

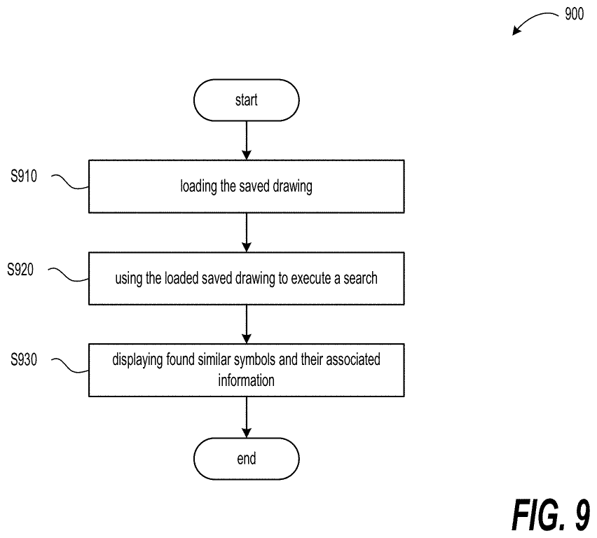

FIG. 9 is a flow chart illustrating an exemplary method or system usage flow 900 for using a saved curve to execute a search sharing according to some embodiments of the present disclosure. At step S910, a curve previously saved can be loaded. For example, the user interface 350 can display curves stored in the database 330, and a user can select and load one of the curves, which can be saved by the user or other users in the user interface 350 previously. At step S920, the loaded saved curve can be used to execute a search. At step S930, found similar symbols and their associated information can be displayed in the user interface 350.

The system usage flows 500-900 can be implemented by software, firmware, hardware or a combination thereof, such as those shown in the system 300.

In an embodiment, the search engine 320 can search all tickers (including the ticker that the user is currently searching), e.g., stocks, ETF, foreign exchange etc., to find out which ticker has the best matching (e.g., highest similarity scores) of one or more drawn curves in the same period of time. In another embodiment, the search engine 320 may search all tickers to find out which ticker has the best matching of one or more drawn curves in any period of time with any start and end time. In some embodiments, the search engine 320 can also search the same ticker to find out what other periods of time best matching the period of time specified. For example, when a user uses the timeseries of price of ticker $AAPL in Q2 2022 to execute search with following use cases: (1) what are the stocks (not $AAPL) that has the most similar timeseries of price (similarity score) at Q2 2022 as ticker $AAPL performed in Q2 2022; (2) what is other periods of time in history of $AAPL is downtrend like Q2 2022 of $AAPL; and (3) what is other periods of time in history of a ticker (not $AAPL) in stock markets in downtrend like Q2 2022 of $AAPL, the search engine 320 will find out ticker candidates for the three use cases, respectively, and display on the user interface 350 (1) One of the Return: Q2 2022 of $ANET; (2) One of the Return: Q4 2008 of $AAPL; and (3) One of the Return: Q2 2005 of $IBM.

The present disclosure provides some advantages. The efforts to draw a curve each time when intending to get search results are reduced. The system 300 can provide a functionality to store the drawn curves in the database 330 for storage and retrieval. Users can deposit and retrieve the drawn curves from the database 330 and present them on the user interface 350. The drawn curves can be shared with other users.

In one use case, a user might want to draw the curve or pattern based on a symbol, for example, drawing the price history of the symbol AAPL, and intend to get a search result. To reduce the efforts of users to mimic and draw the existing symbol price history, the system 300 can enable users to type in the symbol as text and retrieve its recent price from the typed symbol and execute the search service. In this way, a user does not need to mimic the price history in canvas and get the desired result. Therefore, the result will be more accurate, contrasting to mimicking the specific symbol.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A system, comprising:
an interface configured to receive an input curve or a first symbol and one or more parameters; and
a search engine coupled to the interface, the search engine configured to:
search a database for one or more second symbols based on the input curve and the parameters or based on a first curve of the first symbol corresponding to the parameters; and
display the second symbols on the interface.

2. The system of claim 1, wherein the interface is further configured to display a plurality of default curves, and the input curve is one of the default curves.

3. The system of claim 1, wherein the interface includes a graphic user interface (GUI) with touch screen capability, and the input curve is drawn on the GUI.

4. The system of claim 1, wherein a second curve of each of the second symbols has a similarity score over a threshold.

5. The system of claim 1, wherein the interface is further configured to receive one or more indicators, and the second symbols are searched based on the indicators, the input curve and the parameters or based on the indicators and the first curve of the first symbol corresponding to the parameters.

6. The system of claim 1, wherein the interface is further configured to receive one or more candlestick patterns, and the second symbols are searched based on the candlestick patterns, the input curve and the parameters or based on the candlestick patterns and the first curve of the first symbol corresponding to the parameters.

7. The system of claim 1, wherein the parameters include a time range and a time interval.

8. The system of claim 1, wherein the search engine is further configured to save the input curve in the database.

9. The system of claim 1, further comprising a memory coupled to the search engine, wherein the search engine is further configured to save the input curve in the memory.

10. The system of claim 1, wherein the interface is configured to receive the input curve, and the search engine is configured to search the database for the second symbols based on the input curve and the parameters.

11. The system of claim 1, wherein the interface is configured to receive the first symbol, and the search engine is configured to search the database for the second symbols based on the first curve of the first symbol corresponding to the parameters.

12. The system of claim 1, wherein the first symbol and the second symbols belong to at least two financial markets.

13. A method, comprising:
receiving an input curve or a first symbol and one or more parameters;
searching a database for one or more second symbols based on the input curve and the parameters or based on a first curve of the first symbol corresponding to the parameters; and
displaying the second symbols.

14. The method of claim 13, further comprising displaying a plurality of default curves, wherein the input curve is one of the default curves.

15. The method of claim 13, further comprising receiving one or more indicators, wherein the second symbols are searched based on the indicators, the input curve and the parameters or based on the indicators and the first curve of the first symbol corresponding to the parameters.

16. The method of claim 13, further comprising receiving one or more candlestick patterns, wherein the second symbols are searched based on the candlestick patterns, the input curve and the parameters or based on the candlestick patterns and the first curve of the first symbol corresponding to the parameters.

17. The method of claim 13, wherein a second curve of each of the second symbols has a similarity score over a threshold.

18. The method of claim 13, further comprising saving the input curve.

19. The method of claim 13, wherein the first symbol and the second symbols belong to at least two financial markets.

20. The method of claim 13, wherein the parameters include a time range and a time interval.
